(19) United States
(12) Patent Application Publication
(10) Pub. No.: US 2013/0343177 A1
(43) Pub. Date: Dec. 26, 2013

(54) SWITCHING SYSTEM AND METHOD FOR IMPROVING SWITCHING BANDWIDTH

(71) Applicant: Huawei Technologies Co., Ltd., Shenzhen (CN)

(72) Inventors: Feng HONG, Shenzhen (CN); Cheng CHEN, Shenzhen (CN); Rong FAN, Shenzhen (CN)

(73) Assignee: Huawei Technologies Co., Ltd., Shenzhen (CN)

(21) Appl. No.: 13/965,187

(22) Filed: Aug. 12, 2013

Related U.S. Application Data
(63) Continuation of application No. 12/181,617, filed on Jul. 29, 2008, now abandoned.
Application No. 12/181,617 is a continuation of application No. PCT/CN2007/070169, filed on Jun. 25, 2007.

(30) Foreign Application Priority Data
Jun. 23, 2006 (CN) 200610061326.0

(51) Int. Cl. H04L 12/931

(52) U.S. Cl. CPC H04L 49/40
USPC 370/219; 370/401

(57) ABSTRACT

A switching system compatible with ATCA/ATCA 300 architecture and a method for improving switching bandwidth, including: a backplane, a plurality of node boards and at least two hub boards; the node boards are connected with the hub nodes through the backplane; each node board is connected with the at least two hub boards; different data is transmitted on at least two data links between the node boards and the at least two hub boards, and the at least two hub boards cooperate with each other to implement a data switching between the node boards.

### CROSS-REFERENCE TO RELATED APPLICATIONS

This application is a continuation of U.S. patent application Ser. No. 12/181,617, filed Jul. 29, 2008, which is a continuation of International Application No. PCT/CN2007/070169, filed Jun. 25, 2007. This application claims the benefit of Chinese Application No. 200610061326.0, filed Jun. 23, 2006. The afore-mentioned patent applications are hereby incorporated by reference in their entireties.

### FIELD

The present disclosure relates to the field of communications, and in particular, to a switching system compatible with ATCA/ATCA300 architecture and a method for improving the switching bandwidth.

### BACKGROUND

The statements in this section merely provide background information related to the present disclosure and may not constitute prior art.

Advanced Telecommunications Computing Architecture (ATCA) is an open industry standard architecture established and developed by PCI Industrial Computer Manufacturers Group (PICMG), and targets at a hardware platform technology commonly used for communication devices and computer servers. The ATCA includes various specifications involving the frame structure, power supply, heat dispersion, single board structure, backplane interconnection topology, system administration and proposals for a switching network and so on. The ATCA is fit for the cabinet of 600 mm depth. The PICMG has also established a platform architecture standard of ATCA300 to meet the requirements of the cabinet of 300 mm depth, and the backplane of ATCA is compatible with that of ATCA300.

The ATCA is a structure including a mid backplane and front and rear boards. A hub board and a node board both are the front boards. Node boards are connected with each other in a full mesh mode or through the hub boards. The ATCA may support sixteen slots (in 21-inch cabinet) at most, and support fourteen slots in a 19-inch cabinet. Each slot in ATCA may be divided into three zones including zone 1, zone 2 and zone 3. The zone 1 is an interconnection area for power supply and management, the zone 3 is an interconnection area for a front board and a corresponding rear board, and zone 2 is an interconnection area between the node board and the hub board (dual fabric star topology) or between the node boards (full mesh topology). If the full mesh topology is adopted, the ATCA may support sixteen node boards at most. If the dual fabric star topology is adopted, the ATCA may support fourteen node boards and two hub boards at most, and each hub board needs to be interconnected with other fifteen single boards (fourteen node boards and one hub board). If a dual-dual fabric star topology is adopted, the ATCA may support twelve node boards and four hub boards at most, and each hub board needs to be interconnected with other fifteen single boards (twelve node boards and three hub boards).

PICMG 3.0 defines three kinds of switching interconnection topologies, including full mesh, dual fabric star and dual-dual fabric star. In terms of these switching interconnection topologies, the interconnection between two node boards provides eight pairs of difference signals (four pairs of difference signals are sent and four pairs of difference signals are received) under the condition that a system is configured with sixteen slots or fourteen slots. In the present switching interconnection technologies, the operating rate of the physical link is mainly 2.5 Gb/s, 3.125 Gb/s, 5 Gb/s and 6.25 Gb/s.

As shown in FIG. 1, in the full mesh topology, all node boards 11 are directly connected with each other (FIG. 1 illustrates a full mesh architecture configured with eight node boards). The PICMG 3.0 may support sixteen node boards at most to implement the full mesh topology. However, in the full mesh topology architecture, even the operating rate of the physical link is 6.25 Gb/s, the communication bandwidth between two node boards is only 20 Gb/s. In addition, in specific applications, the cost for implementing the full mesh topology for sixteen node boards is very high. Generally, the full mesh topology is only adopted for a system with less than eight nodes, which is not able to meet the requirements of a large capacity device.

As shown in FIG. 2, the dual fabric star topology structure includes two hub board nodes 22 (logical slot number is 1 and 2 respectively) and may be configured with at most fourteen node boards (logical slot number is 3-16). The node boards 21 are all interconnected with the hub boards 22, and the communication between the node boards 21 is implemented through the hub boards. It is specified in the PICMG 3.0 that two switching networks operate in a redundancy mode (PICMG 3.0 Specification, Page 294, Para. 6.2.1.1). In the redundancy operating mode, only the main hub board can implement the switching function, while the backup hub board does not implement the switching function; or both hub boards can implement the switching function, while the node board only receives the data from the main hub board and does not receive the data from the backup hub board. Hence, in the dual fabric star topology, even if the operating rate of the physical link is 6.25 Gb/s, the node board may only provide a bandwidth of 20 Gb/s and one user interface with line rate of 10 Gb/s.

The dual-dual fabric star topology structure is similar to the dual fabric star topology. The number of the hub boards is increased from two to four (the logical slot number is 1, 2, 3 and 4 respectively) and twelve node boards (the logical slot number is 5-16) may be configured at most. The node boards are all interconnected with the hub boards. The communication between the node boards is implemented through the hub boards. It is specified in the PICMG 3.0 that four hub boards are divided into two groups and each group operates in a dual fabric star mode independently (PICMG 3.0 Specification, Page 294, Para. 6.2.1.2). The two hub boards with the logical slot number of 1 and 2 belong to a group and are in a dual star switching fabric interconnection structure, and the two hub boards with the logical slot number of 3 and 4 belong to another group and are also in a dual fabric star switching network interconnection structure. In the dual-dual fabric star topology, a switching structure with two dual fabric star topologies is adopted and the communication bandwidth between the node boards is doubled. However, because the two switching structure are independent from each other, the data stream bandwidth for the communication between node boards is still the bandwidth of a dual fabric star topology, and the only difference is that two data streams may be supported.

Currently, in an application of the telecom platform, it is a basic requirement to provide a user interface of 10 Gb/s in the aggregation layer of a Metropolitan-Area Network (MAN). With the rapid development of Internet, telecom equipment may be required to provide a higher bandwidth in recent years. The equipment in the aggregation layer may even be required to provide a user interface of 40 Gb/s. Considering the speedup ratio and the processing overhead of the switching network and service processing, the user interface of 40 Gb/s generally requires the backplane of the node board to provide a bandwidth of 60 Gb/s or more. Therefore, under the current definition of PICMG 3.0 standard, none of the full mesh topology, dual fabric star topology and the dual-dual fabric star topology can provide enough bandwidth for the communication between node boards.

### SUMMARY

The present disclosure provides a switching system and method for improving a switching bandwidth, so as to expand a switching bandwidth between node boards and meet the requirement for bandwidth of a user interface.

Hence, various embodiments provide the flowing solutions.

A switching system compatible with ATCA/ATCA300 architecture for improving switching bandwidth, includes:

a backplane, a plurality of node boards and at least two hub boards, wherein the node boards are connected with the hub boards through the backplane;

each node board is connected with the at least two hub boards;

different data is transmitted on at least two data links between the node boards and the at least two hub boards, and the at least two hub boards cooperate with each other to implement data switching between the node boards.

A switch method for improving switching bandwidth, includes:

demultiplexing by a node board, data to ingress ports of at least two hub boards; and

switching, by the at least two hub boards, the data input from the ingress ports to respective egress ports, and outputting the data to another node board, and

multiplexing, by a node board, data from egress port of at least two hub board, so as to implement a data switching between node boards.

According to the above solutions provided by various embodiments, under the condition that the solution is compatible with the physical structure and layout of a backplane connector defined by current ATCA/ATCA300, a switching interconnection bandwidth is expanded through a way of multi-plane switching, more communication bandwidth is provided between node boards, and the requirements for the bandwidth by a user may be fulfilled. Moreover, the switching interconnection bandwidth may increase linearly with the increase of the number of hub boards, and the hub boards and node boards may be configured flexibly in accordance with the requirements for bandwidth in various applications.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic diagram illustrating the structure of a full mesh topology in ATCA in the prior art;

FIG. 2 is a schematic diagram illustrating the structure of a dual fabric star topology in ATCA in the prior art;

FIG. 3 is a block diagram illustrating the principle of a system according to an embodiment (dual plane switching);

FIG. 4 is a diagram illustrating the backplane connection topology configured with two hub boards (dual plane switching) according to an embodiment;

FIG. 5 is a block diagram illustrating the principle of an embodiment (triple plane switching);

FIG. 6 is a diagram illustrating the backplane connection topology configured with three hub boards according to an embodiment;

FIG. 7 is a diagram illustrating the backplane connection topology configured with four hub boards according to an embodiment; and

FIG. 8 is a diagram illustrating the backplane connection topology configured with five hub boards according to an embodiment.

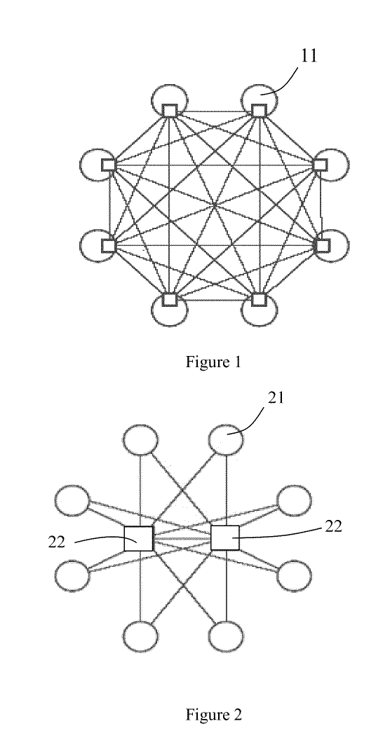

### DETAILED DESCRIPTION

The following description is merely exemplary in nature and is not intended to limit the present disclosure, application, or uses.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

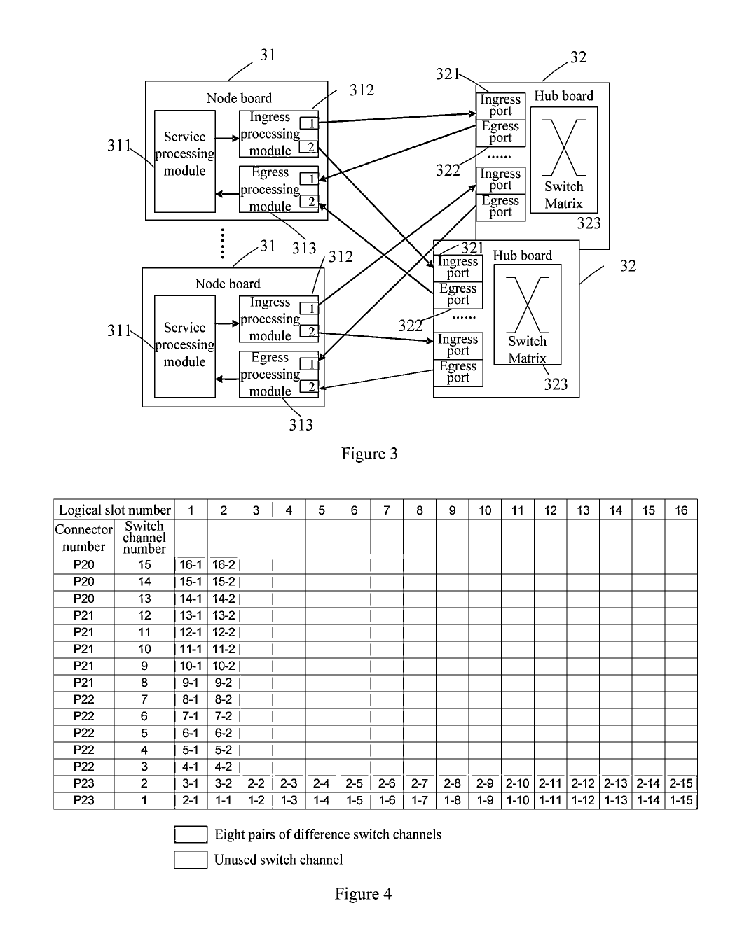

As shown in FIG. 3, in a first embodiment, the system is configured with fourteen node boards 31 and two hub boards 32. Each node board is connected with the two hub boards through a backplane (not shown). The fabric interface in zone 2 of the backplane includes four connectors P20, P21, P22 and P23, and fifteen switching channels may be provided at most for interconnection with other single boards.

In this embodiment, the node board 31 includes a service processing module 311, an ingress processing module 312 and an egress processing module 313, wherein the ingress processing module 312 and the egress processing module 313 are connected with the service processing module 311 respectively. The ingress processing module and egress processing module form a transmission module, and each node board includes at least one transmission module. The ingress processing module 312 is adapted to schedule data and dispatch data to each hub board 32 in proportion. The egress processing module 313 receives data from each hub board 32 and performs a data convergence and sequence ordering. The service processing module 311 mainly performs the service processing or provides an interface for network interconnection.

The hub board 32 includes a switching matrix 323, a plurality of ingress ports 321 and a plurality of egress ports 322. The hub board 32 switches data input from the ingress port 321 to the egress port 322 through the switching matrix 323 for outputting according to the routing information of the data packet.

In this embodiment, the ingress processing module 312 of each node board 31 is connected to the ingress ports 321 of the hub boards 32 respectively, and the egress processing module 313 is connected to the egress port 322 of the hub boards 32 respectively. Hence, the node board 32 serves as an input stage and an output stage during data communication, and the hub board 32 serves as a switching plane for implementing the switching function. The ingress processing module 312 of the node board 31 dispatches data to the ingress port 321 of each hub board 32 in proportion through data scheduling. The hub board 32 switches the data input from the ingress port 321 to the egress port 322 with the switching matrix 323 according to the routing information for the data packet, outputs the data to the egress processing module 313, and performs the data convergence and sequence ordering, thus accomplishes the data communication between node boards 31. In this embodiment, the node board provides eight pairs of difference signals, wherein the ingress processing module 312 provides four pairs for sending data and the egress processing module 313 provides four pairs for receiving data. A serial data interconnection is adopted for the difference signal.

When a first hub board fails, the transmission module dispatches data to the data links formed by the connection between the transmission module and the hub boards except for the first hub board, and receives the data on the data links formed by the connection between the transmission module and the hub boards except for the first hub board, so as to accomplish the data aggregating and reassembling. The data switching between the node boards is accomplished by cooperation of the hub boards, except for the first hub board.

FIG. 4 is a diagram illustrating the backplane connection topology in the system shown in FIG. 3 according to the first embodiment. The backplane is connected with two hub board slots (each table item represents eight pairs of difference signals, including four pairs of signals received and four pairs of signals to be sent). At this point, the system operates in a dual plane switching mode, the logical slot number of hub boards 32 is 1 and 2, and the logical number of node boards 31 is 3-16. Data in the table of FIG. 4 represents Slot-Channel. For example, data for “Slot: 1; Channel: 1” is “2-1”, which indicates that the channel 1 of slot 1 is connected with channel 1 of slot 2.

Because two hub boards are used, the node board 31 merely uses the switching channel 1 and switching channel 2, so that the communication bandwidth between the node boards is eight times higher than the operating rate of the physical link (Link Speed×8). If the “Link Speed” is 2.5 Gb/s, the interconnection bandwidth between the nodes is 20 Gb/s (including the 8B/10B overhead). Hence, the node board may provide a user interface of 10 Gb/s line rate. If one hub board fails, the communication between the node boards may continue through the other hub board, and the communication bandwidth is 8 Gb/s.

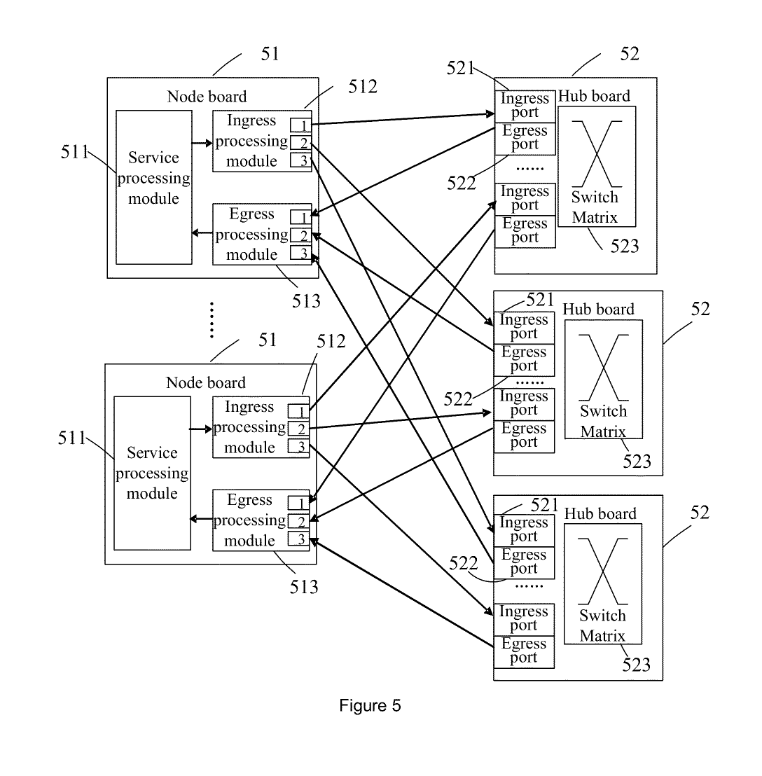

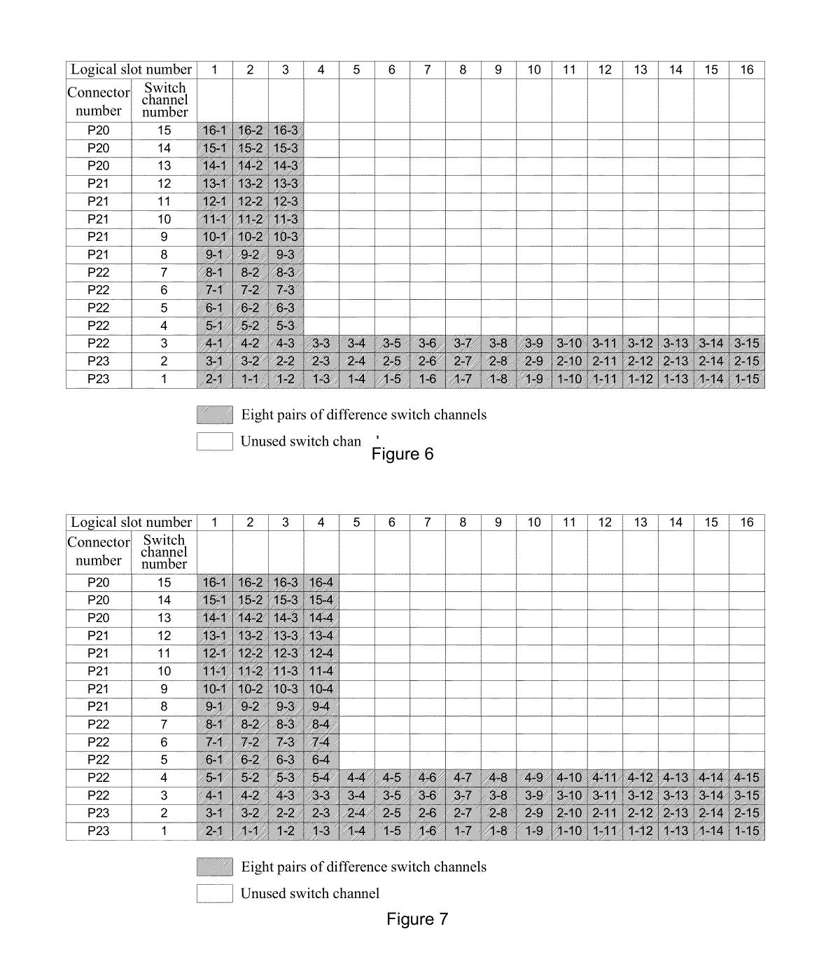

In the second embodiment, three hub boards may be configured in the system. At this point, the system operates in a triple plane switching mode (also referred to as “2+1”), as shown in FIG. 5. Logical slots 1, 2 and 3 are dedicated as hub board slots 52, and logical slots 4-16 are node board slots 51. The structure of the node boards 51 is same as that of the embodiment shown in FIG. 3, and includes a service processing module 511, an ingress processing module 512 and an egress processing module 513. The structure of the hub boards 52 is same as that of the embodiment shown in FIG. 3, and includes a switching matrix 523, an ingress port 521 and an egress port 522. The node board slots use channels 1, 2 and 3, and the backplane connection topology is as shown in FIG. 6. The communication bandwidth between the node boards is “Link Speed×12”. If the “Link Speed” is 2.5 Gb/s, the interconnection bandwidth between the nodes is 30 Gb/s (including the 8B/10B overhead). The hub board slot also provides interconnection resources for node boards. If a large switching bandwidth is not required, the node board may also be inserted into the hub board slot. For example, the node board may be inserted into logical slot 3, and at this point, the interconnection topology is same as the structure when the system is configured with two hub boards, and the node board of the first embodiment may be compatible with the logical slot 3-16.

In the third embodiment, four hub boards may be configured in the backplane switching interface. At this point, the system operates in a four plane switching mode (also referred to as “3+1”). Logical slots 1, 2, 3 and 4 are the hub boards and logical slots 5-16 are the node boards. The node board slots use channels 1, 2, 3 and 4. The backplane connection topology is as shown in FIG. 7. The communication bandwidth between node boards is “Link Speed×16”. If the “Link Speed” is 2.5 Gb/s, the interconnection bandwidth between nodes is 40 Gb/s (including the 8B/10B overhead). If the node board is inserted into the logical slot 4, the interconnection topology is same as the structure when it is configured with three hub boards, and the node board of the second embodiment may be compatible with the logical slot 4-16. If the node boards are inserted into slots 3 and 4, the interconnection topology is same as the structure when it is configured with two hub boards, and the node board of the first embodiment may be compatible with the logical slot 3-16.

In the fourth embodiment, five hub boards may be configured in the backplane switching interface. At this point, the system operates in a five plane switching mode (also referred to as “4+1”). Logical slots 1-5 are the hub boards and logical slots 6-16 are the node boards. The node board slots use channels 1, 2, 3, 4 and 5.

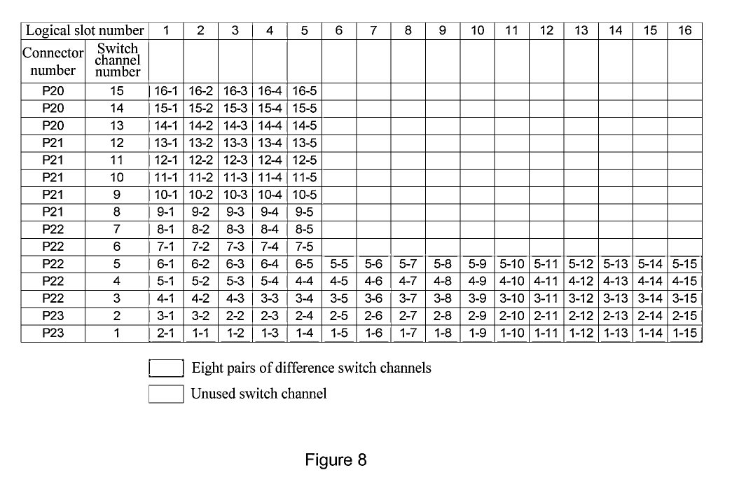

The backplane connection topology is as shown in FIG. 8. The communication bandwidth between the node boards is “Link Speed×20”. If the “Link Speed” is 2.5 Gb/s, the interconnection bandwidth between the nodes is 50 Gb/s (including the 8B/10B overhead). If a node board is inserted into the logical slot 5, the interconnection topology is same as the structure when it is configured with four hub boards, and the node board of the third embodiment may be compatible with the logical slot. If node boards are inserted into slots 5 and 4, the interconnection topology is same as the structure when it is configured with three hub boards, and the node board of the second embodiment may be compatible with the logical slot. If the node boards are inserted into slots 5, 4 and 3, the interconnection topology is same as the structure when it is configured with two hub boards, and the node board of the first embodiment may be compatible with the logical slot.

By analogy, more hub board slots (more than five) may be configured to obtain larger switching interconnection bandwidth.

Table 1 shows the communication bandwidths (excluding the 8B/10B overhead) between node boards obtained by different operating rates of the physical link in various configurations.

TABLE 1

| | | 2.5 Gb/s | 3.125 Gb/s | 5 Gb/s | 6.25 Gb/s |
|---|---|---|---|---|---|
| Two hub | Normal | 16 Gb/s | 20 Gb/s | 32 Gb/s | 40 Gb/s |
| boards | One fails | 8 Gb/s | 10 Gb/s | 16 Gb/s | 20 Gb/s |
| Three hub | Normal | 24 Gb/s | 30 Gb/s | 48 Gb/s | 60 Gb/s |
| boards | One fails | 16 Gb/s | 20 Gb/s | 32 Gb/s | 40 Gb/s |
| Four hub | Normal | 32 Gb/s | 40 Gb/s | 64 Gb/s | 80 Gb/s |
| boards | One fails | 24 Gb/s | 30 Gb/s | 48 Gb/s | 60 Gb/s |
| Five hub | Normal | 40 Gb/s | 50 Gb/s | 80 Gb/s | 100 Gb/s |
| boards | One fails | 32 Gb/s | 40 Gb/s | 64 Gb/s | 80 Gb/s |

In above embodiments, each hub board is not limited to implement the function of one switching plane, but may perform the switching of a plurality of switching planes (e.g., one hub board may implement the switching function of two switching planes). The operating rate of the physical link for system interconnection is not limited to 2.5 Gb/s, 3.125 Gb/s, 5 Gb/s and 6.25 Gb/s, and the physical link may operate at other speed. The higher the operating rate is, the larger the switching bandwidth of the node board is.

In addition, in above embodiments, it is not limited to use eight pairs of difference signals (four pairs of signals received and four pairs of signals to be sent) for the node board to interconnect with the hub board, other number of difference signals may also be adopted for implementing the interconnection between the node board and the hub board, and different pin map may also be adopted in the signal definition.

In addition, in above embodiments, the number of slots (the node board slots and the hub board slots) in the system is not limited to sixteen and may be other value (for example, fourteen slots in a 19-inch cabinet).

Though the present disclosure is described above with preferred embodiments, it is not limited to those embodiments. It is noted that all modifications, equivalent replacements and improvements made within the spirit and principle shall fall into the protect scope of the present disclosure.

What is claimed is:

1. A switching system compatible with ATCA/ATCA300 architecture for improving switching bandwidth, comprising:
a plurality of node boards, at least two hub boards and a backplane, said a plurality of node boards and the at least two hub boards being inserted into the backplane,
wherein each of the node boards is connected with each of the at least two hub boards through the backplane,
wherein the backplane comprises N hub board slots and M board slots, the hub board slots are interconnected with each other, the hub board slots are connected with the node board slots, N is a integer lager than 2, M is a is a integer lager than 1; the n hub board slots each are inserted into with one of the hub boards, the N−n hub board slots each are inserted into with one of the node boards instead of one of the hub boards, and the M node board slots each are inserted into with one of the node boards, n is a integer less than or equal to N;
at least two data links between each of the node boards and the at least two hub boards; wherein each of the at least two data links is configured to provide communication bandwidth, the at least two hub boards cooperating with each other to implement data switching between a first node board and a second node board.

2. The switching system for improving switching bandwidth according to claim 1, wherein each of the node boards comprises at least one transmission module.

3. The switching system for improving switching bandwidth according to claim 2, wherein each of the hub boards comprises a plurality of ports, the plurality of ports are connected with the transmission module to form a plurality of data links.

4. The switching system for improving switching bandwidth according to claim 3, wherein each of the ports comprises an ingress port and an egress port.

5. The switching system for improving switching bandwidth according to claim 4, wherein the transmission module comprises:
an ingress processing module, adapted to dispatch data to the plurality of data links; and
an egress processing module, adapted to receive different data transmitted on the plurality of data links, and implement a data convergence and reassembling.

6. The switching system for improving switching bandwidth according to claim 5, wherein the ingress processing module is connected with the ingress ports on the at least two hub boards respectively to form at least two ingress data links; and
the egress processing module is connected with the egress ports on the at least two hub boards respectively to form at least two egress data links.

7. The switching system for improving switching bandwidth according to claim 2, wherein,
when at least one hub board fails, the transmission module connected with the failed hub board distributes data to be transmitted to other data links connected with a hub board without failure, and receives data on other data links connected with the hub board without failure, so as to implement data convergence and reassembling.

8. The switching system for improving switching bandwidth according to claim 7, wherein, when the at least one hub board fails, other hub boards except for the failed hub board cooperate with each other to implement a data switching function between the node boards.

9. The switching system for improving switching bandwidth according to claim 1, wherein n hub boards are inserted into the backplane, each of the node boards occupies n channels in the node board slot inserted into, each of the n channels is connected with a respective one of the n hub boards.

10. The switching system for improving switching bandwidth according to claim 1, wherein,
number of the node boards and the hub boards is configured in accordance with requirements for the number of the node boards and the switching bandwidth.

11. A switching method for improving switching bandwidth, comprising:
demultiplexing, by a node board of a plurality of node boards, data to ingress ports of at least two hub boards in proportion, wherein the switching system includes a backplane receiving the plurality of node boards and the at least two hub boards, the node boards are connected with the hub boards through the backplane, each of the node boards is connected with each of the at least two hub boards; and
switching, by each of the at least two hub boards, the data input from the ingress ports to respective egress ports, and outputting the data to another node board of the node boards, so as to implement a data switching between any two of the node boards.

12. The method for improving switching bandwidth according to claim 11, wherein,
when a hub board fails, the node board switches data through a hub board without failure.

13. A switching system compatible with ATCA/ATCA300 architecture for improving switching bandwidth, comprising:
first and second node boards, at least two hub boards and a backplane, said first and second node boards and the at least two hub boards being inserted into the backplane, wherein each of the node boards is connected with each of the at least two hub boards through the backplane;
at least two data links between each of the node boards and the at least two hub boards; wherein each of the at least two data links is configured to provide communication bandwidth between the first node board and the second node board, the at least two hub boards cooperating with each other to implement data switching between the first node board and the second node board, wherein the first node board divides a data stream and dispatches data of the data stream to each of the at least two hub boards in proportion, and the second node board receives the data from each of the at least two hub boards and performs a data convergence and sequence ordering of the data stream.

14. The switching system for improving switching bandwidth according to claim 13, wherein each of the node boards comprises at least one transmission module, the transmission module comprises:
an ingress processing module, adapted to dispatch data to the plurality of data links; and
an egress processing module, adapted to receive different data transmitted on the plurality of data links, and implement a data convergence and reassembling.

15. The switching system for improving switching bandwidth according to claim 14, wherein each of the hub boards comprises a plurality of ports, each of the ports comprises an ingress port and an egress port;
the ingress processing module is connected with the ingress ports on the at least two hub boards respectively to form at least two ingress data links; and
the egress processing module is connected with the egress ports on the at least two hub boards respectively to form at least two egress data links.

16. The switching system for improving switching bandwidth according to claim 14, wherein,
number of the node boards and the hub boards is configured in accordance with requirements for the number of the node boards and the switching bandwidth.
